(19) United States
(12) Patent Application Publication
(10) Pub. No.: US 2024/0102482 A1
(43) Pub. Date: Mar. 28, 2024

(54) Coolant Pump Having an Improved Gap Seal

(71) Applicant: NIDEC GPM GmbH, Auengrund OT Merbelsrod (DE)

(72) Inventors: Marcel Berner, Hildburghausen (DE); Franz Pawellek, Lautertal (DE); Constantin Richlich, Coburg (DE); Toni Steiner, Bachfeld (DE)

(21) Appl. No.: 17/769,086

(22) PCT Filed: Sep. 2, 2020
(86) PCT No.: PCT/EP2020/074437

§ 371 Date: Apr. 14, 2022

(30) Foreign Application Priority Data
Oct. 31, 2019 (DE) 10 2019 129 494.0

(51) Int. Cl. F04D 29/16; F04D 29/041; F04D 29/62

(52) U.S. Cl. CPC F04D 29/167; F04D 29/0413; F04D 29/622; F04D 7/02

(57) ABSTRACT

A coolant pump that includes: a rotating slide ring, which is arranged on the pump impeller towards an axial end of the entry opening; a static slide ring, which is arranged on the pump housing around the mouth of the inlet opposite the rotating slide ring; the rotating slide ring has a sliding surface and the static slide ring has a sliding surface, the sliding surfaces are facing one another and form a sliding bearing that receives a force directed axially away from the pump impeller to the pump housing; and a microstructure for creating a hydrodynamic lubricating film between the sliding surfaces is formed on at least one of the sliding surfaces facing one another, the microstructure includes cavities that collect liquid coolant on the at least one sliding surface.

### CROSS-REFERENCE TO RELATED APPLICATIONS

This application is a US National Stage Entry of PCT/EP2020/074437 filed on Sep. 2, 2020, which claims priority to DE 10 2019 129 494.0 filed on Oct. 31, 2019.

### FIELD

The present invention relates to a coolant pump having an improved gap seal between a suction side and a compression side of the coolant pump, in particular for delivering cooling water or a water-based coolant in the exemplified uses of a coolant circuit for an internal combustion engine or for an electric traction motor on a vehicle.

### BACKGROUND

Various centrifugal pumps of the radial pump-type or axial pump-type are known which draw in a liquid delivery medium axially to the pump shaft and build up a delivery pressure by a radially or axially accelerating pump impeller. There is generally a gap between the pump impeller and a housing section leading thereto, which gap simultaneously forms a boundary between a suction side and a compression side of the pump. In order to ensure a sealing effect between the suction side and the compression side in this region, an attempt is made to keep the gap between the pump impeller and the housing as small as possible and so a gap seal is created, i.e. a gap having a seal-effective gap dimension of e.g. 20 to 80 micrometers is produced.

However, when manufacturing a pump, the gap dimension of a gap seal between the pump impeller and the housing is considerably influenced by the result of a tolerance chain of adaptations, which chain is produced on a case-by-case basis after assembling a plurality of pump components. Manufacturing steps having an effect on the tolerance chain relate e.g. to adjusting how the pump impeller sits on the shaft, how the shaft sits in a shaft bearing, how the shaft bearing sits in the housing, etc. If the pump housing is produced in multiple parts, i.e. in particular if the housing section leading to the pump impeller and a housing section in which the shaft is accommodated are not in one piece, an adaptation between the corresponding housing sections likewise has an effect on the result of the tolerance chain, which influences the gap seal between the suction side and the compression side.

In the prior art, designs of centrifugal pumps are known which provide a sealing arrangement between the pump impeller and the housing.

For example, DE 90 01 229 U1 discloses a gap seal between an impeller and a stepped housing of a centrifugal pump, the seal gap extending coaxially to the shaft.

DE 199 60 160 B4 discloses a device for optimizing the gap width in centrifugal pumps for compensating for manufacturing tolerances and positional deviations in relation to a housing bore. Located on the outer periphery of the free end of an impeller is a bead with a directly adjoining gear seal collar. The gear seal collar is in contact with a gap ring which is arranged in a stop surface of a housing inner bore of the pump housing. Arranged next to each other on the inner sleeve of the gap ring is a centering seat, a ring seal collar and a free seat, and on the outer sleeve of the gap ring there are webs or radial fins.

However, seals, in particular sealing lips per se, are subject to wear owing to abrasion, the effect of impurities or other particles and foreign bodies, embrittlement, etc. Furthermore, seals have a coefficient of friction which increases the required drive energy and impairs the energy efficiency of the pump operation.

Furthermore, in the prior art designs of centrifugal pumps are known in which axially displaceable mounting of the pump impeller is provided on the shaft. This arrangement allows, in operation, the pump impeller on the shaft to be drawn towards the suction side of the pump until it rests against the housing.

DE 10 2009 027 645 A1 describes a circulating pump not of the type in question for a dishwasher. An impeller of the pump is provided with a sliding region and the housing is provided with a spacer disc which is stationary with respect to an intake channel. In operation, the sliding region and the spacer disc have a dual function as a bearing for the impeller and as a sealing system to prevent the return of water into the intake channel.

Since, in this design, the shaft bearing does not receive axial forces, wear-causing friction occurs between the pump impeller and the housing. The wear and a coefficient of friction between the pump impeller and the housing are influenced in such a pump design by use-specific factors, such as a contact pressure dependent on the delivery capacity or rheological and tribological properties of an e.g. oil-based or water-based delivery medium. In comparison with the previously mentioned circulating pump for flushing liquors, it appears to be questionable whether a corresponding pump design is equally suitable for use as a coolant pump, in particular in terms of the higher delivery capacities, i.e. a higher contact pressure over longer periods of operation and a water-based delivery medium without a component capable of lubrication in the form of a surfactant-containing flushing medium.

### SUMMARY

It is an object of the invention to provide a use-optimized coolant pump which provides a durable and low-friction gap seal between a suction side and a compression side. The object is achieved by a coolant pump having the features of claim 1.

The coolant pump in accordance with the invention is characterized in particular by: a rotating slide ring, which is arranged on a pump impeller towards an axial end of an entry opening; a static slide ring, which is arranged on a pump housing around a mouth of an inlet opposite the rotating slide ring; wherein the rotating slide ring has a sliding surface and the static slide ring has a sliding surface, wherein the sliding surfaces are facing one another and form a sliding bearing that receives a force directed axially away from the pump impeller to the pump housing; and a microstructure for creating a hydrodynamic lubricating film between the sliding surfaces is formed on at least one of the sliding surfaces facing one another, wherein the microstructure comprises cavities configured to store liquid coolant on the at least one sliding surface.

The present invention provides for the first time a microstructure on a gap seal between a pump impeller and a housing of a centrifugal pump, in particular a coolant pump.

Furthermore, the invention provides for the first time a microstructure on an axial bearing of a centrifugal pump, in particular an axial sliding bearing formed by two slide rings.

In its most general form, the invention is based on the creation of a hydrodynamic lubricating film in a gap seal between a pump impeller and a housing. However, such a hydrodynamic lubricating film is not formed on the basis of chemical requirements, such as an additive capable of lubrication, but on the basis of physical requirements. The hydrodynamic lubricating film provided in accordance with the invention is automatically formed between surfaces facing one another under the proviso of a locally bound collection of a fluid, a rotation in opposite directions and a hydrostatic pressure. The rotation and the hydrostatic pressure are established by the operation of the pump impeller and by a contract pressure dependent upon the delivery pressure. The local binding of the fluid or the use-specific coolant is achieved in accordance with the invention by cavities distributed over the surface, the geometry of the cavities being suitable for collecting or storing droplets of the fluid on a surface. Use of the invention is optimized e.g. by setting the geometry and size of the cavities in relation to wetting behavior, surface tension, adhesion force or rheological properties of a coolant, in particular a water/glycol mixture.

The hydrodynamic lubricating film which is provided in accordance with the invention and is produced by means of the microstructure has several advantages.

Owing to the hydrostatic pressure in the hydrodynamic lubricating film, a direct surface contact between the pump impeller and the housing or between the two slide rings is largely prevented. As a result, very low wear occurs, thus achieving a long service life without any deterioration in the sealing effect.

Likewise, by reason of the lack of direct surface contact at the hydrodynamic lubricating film, very low coefficients of friction are achieved which contribute to high energy efficiency of the pump.

Furthermore, the hydrostatic pressure in the hydrodynamic lubricating film constitutes a sealing-effective, separate pressure zone between an intake pressure and a delivery pressure of the pump. Discrete zones of different pressures constitute in principle a barrier against the penetration of a flow. This principle is known e.g. from seals having grooves or chambers for providing a plurality of different pressure zones between two sealing sides. The hydrodynamic lubricating film which is provided in accordance with the invention and is produced by means of the microstructure thus permanently achieves a sealing effect between a suction side and a compression side of the pump which is better than a gap seal without a hydrodynamic lubricating film.

In summary, the hydrodynamic lubricating film reduces static friction and sliding friction between the sliding surfaces 40, 50 of the slide rings 4, 5 and at the same time provides a hydraulic seal avoiding direct contact between the rotating pump impeller 2 and the pump housing 1, whereby low friction and good wear resistance are achieved for the benefit of service life and operational reliability.

Advantageous developments of the invention are provided in the dependent claims.

According to one aspect of the invention, a material of a slide ring can be different from the material of the pump housing and from the material of the pump impeller. For example, the pump housing is produced from aluminum injection-moulding and the pump impeller is produced from synthetic injection-moulding. However, for the slide rings a more suitable material, i.e. a functional material or a harder material, can be selected for providing the sliding surfaces or the microstructure.

According to one aspect of the invention, the microstructure can be formed on the sliding surface of the rotating slide ring and on the sliding surface of the static slide ring. By using the microstructure on both sliding surfaces, the total volume of collected coolant droplets can potentially be doubled using the same surface density of incorporated cavities.

According to one aspect of the invention, the rotating slide ring and the static slide ring or at least a respective portion of the same forming the sliding surface can be made of a material or of a composite based on an elastomer or a synthetic resin. By using elastomers, a viscoplastic property can be functionally exploited when shearing forces occur at the cavities, as will be explained hereinafter. By using a synthetic resin, manufacturing costs for the slide ring or for the method for producing the microstructure to be incorporated can be reduced.

According to one aspect of the invention, the rotating slide ring and the static slide ring or at least a respective portion of the same forming the sliding surface can be made of a material or of an alloy based on a metal or a ceramic. By using metals or ceramics, high level of surface hardness and thus high wear resistance can be achieved.

According to one aspect of the invention, the microstructure can be formed only on the sliding surface of the static slide ring. By using the microstructure on only one of the two sliding surfaces, manufacturing costs can be reduced. In this context, the static sliding surface provides the advantage that the cavities of the microstructure are not subjected to centrifugal force during operation.

According to one aspect of the invention, the static slide ring or at least a portion of the same forming the sliding surface can be made of a material or of a composite based on an elastomer or a synthetic resin. In the previously mentioned case in which the microstructure is incorporated merely on the static slide ring, a viscoplastic property can thus be functionally exploited when shearing forces occur at the cavities, as will be explained hereinafter.

According to one aspect of the invention, the rotating slide ring or at least a portion of the same forming the sliding surface can be made of a material or of an alloy based on a metal or a ceramic. In the previously mentioned case in which the microstructure is incorporated merely on the static slide ring, a smooth or polished surface with a low level of roughness, i.e. a low coefficient of friction, and a high level of surface hardness for permanently maintaining the low level of roughness can thus be created on the opposite sliding surface of the rotating slide ring.

According to one aspect of the invention, the cavities of the microstructure can have a closed contour towards the surface of the sliding surface. In comparison with a surface roughness, the topology of which contains any shapes of cavities with undefined contours, the closed contour of the cavities ensures reliable collection of droplets for building up a hydrodynamic lubricating film between the sliding surfaces.

According to one aspect of the invention, the cavities of the microstructure can have a dimension of 10 to 40 μm in a depth direction to the surrounding surface. Within said range, a capillary effectiveness of the cavities for collecting the use-specific fluid or coolant in the microstructure of the sliding surface is achieved.

According to one aspect of the invention, the cavities of the microstructure can have a dimension of 15 to 200 μm in a direction of the shortest extension to the surrounding surface. Also in this range, a capillary effectiveness of the cavities for collecting the use-specific fluid or coolant in the microstructure of the sliding surface is achieved.

According to one aspect of the invention, the cavities can have the shape of a spherical cap or of an ellipsoid cap, of an elongate hole or of a groove. In comparison with the shape of a spherical cap, the remaining shapes listed permit orientation and shape-optimization of the microstructure relating to the rotational direction on the sliding surfaces.

According to one aspect of the invention, the sliding surfaces facing one another are perpendicular to the pump shaft. In this embodiment, a perpendicular contact force is produced on the sliding surfaces, whereby a secure configuration for building up a hydrostatic pressure and a hydrodynamic lubricating film is provided.

According to one aspect of the invention, the pump impeller can be directly connected to the pump shaft and the pump shaft can be mounted in an axially movable manner relative to the pump housing. In this embodiment, a simple connection can be produced, such as e.g. a form-fitting extrusion of an impeller body around the shaft.

According to one aspect of the invention, the pump impeller can be arranged in an axially movable manner on the pump shaft and coupled by means of a plug-in coupling. In this embodiment, an axially movable mass and thus mass inertia can be reduced, i.e. a response behavior of an axial movement of the sliding surfaces facing one another is improved when building up the hydrostatic pressure and the hydrodynamic lubricating film.

### BRIEF DESCRIPTION OF THE DRAWINGS

The invention will be explained in greater detail hereinafter with the aid of an exemplified embodiment illustrated in the attached FIG. 2. In the drawings:

FIG. 1 shows a cross-section through a coolant pump from the prior art;

FIG. 2 shows a cross-section through a coolant pump according to one embodiment of the invention.

### DETAILED DESCRIPTION

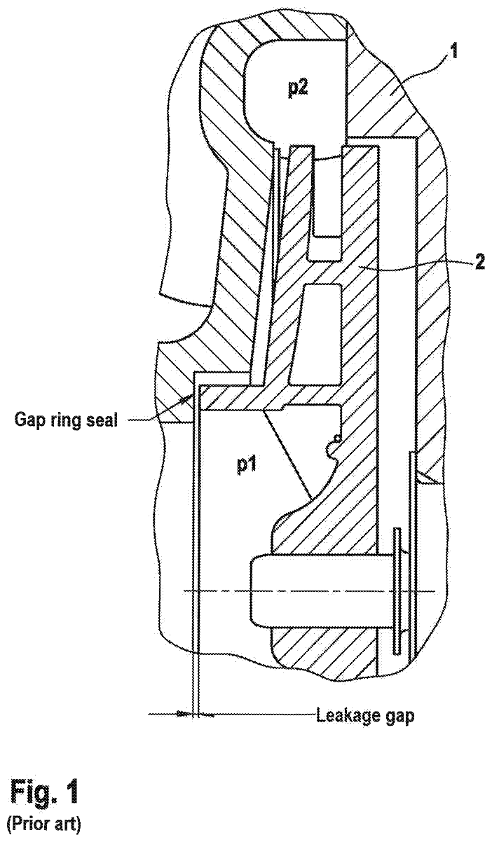

FIG. 1 illustrates a conventional coolant pump. The pump impeller 2 is arranged at a small axial distance from an opposite surface of a housing bore of the pump housing 1. This distance determines a leakage gap of a so-called gap ring seal which constitutes a barrier between an intake region having the lower pressure p1 and a compression region having the higher pressure p2. The effectiveness of the gap ring seal depends upon a size of the leakage gap, through which leakage escapes back into the intake region as part of the already pressurized delivery flow owing to the pressure difference between the higher pressure p2 and the lower pressure p1.

The pump impeller 2 is fixed in relation to an axial position relative to the pump housing 1. The leakage gap is illustrated in enlarged fashion in FIG. 1. In order to produce an effective gap seal for liquids, gap widths of a few tens of micrometers to a few hundred micrometers are generally preferred. However, the precise setting of the leakage gap on a centrifugal pump or the illustrated coolant pump in FIG. 1 is, as previously described, influenced by a tolerance chain of adaptations between the pump components. As a result, it is more difficult to ensure unitary sealing effectiveness at the illustrated gap ring seal in mass production. Leakage from the compression region to the intake region constitutes a hydraulic short-circuit from a portion of the delivery flow and impairs the volumetric efficiency of the pump. The coolant pump in accordance with the invention makes allowance for this problem.

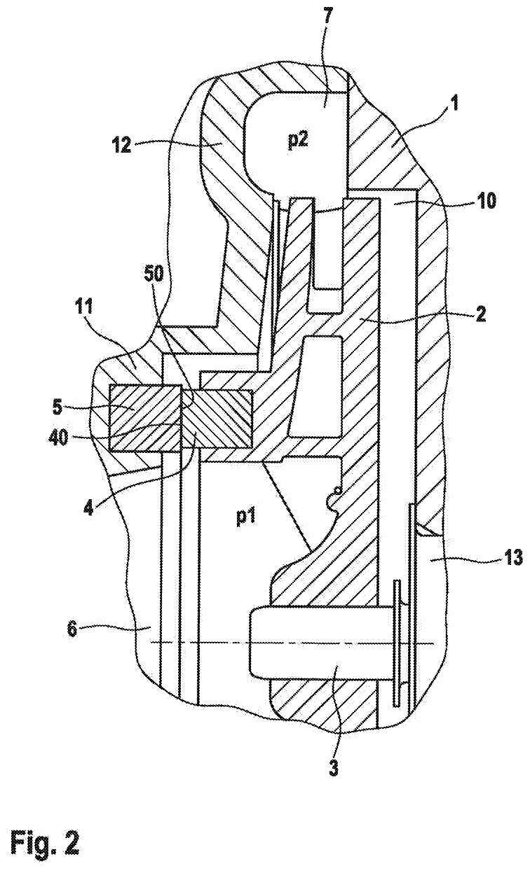

An embodiment of the coolant pump in accordance with the invention will be described hereinafter with reference to FIG. 2.

As can be seen in the axial sectional view of FIG. 2, a pump housing 1 of the coolant pump comprises a hollow chamber formed as a pump chamber 10 in which a pump impeller 2 is accommodated. The pump impeller 2 is fixed to a free end of a pump shaft 3 for conjoint rotation therewith, said pump shaft extending between the pump chamber and a drive side, not shown. The pump shaft 3 is mounted by a radial bearing 13 and is accommodated in the radial bearing 13 in an axially displaceable manner relative to the pump housing 1. On the right-hand side, not shown, of the pump housing 1 there is located the drive side of the coolant pump, on which for example a belt pulley or an electric motor.

A pump cover is inserted into an open axial end of the pump housing 1 and closes off the pump chamber 10 towards the end of the pump shaft 3 at the pump impeller 2. The pump cover forms a centrally arranged intake connection 11 as an inlet 6 of the pump which axially leads to an end face of the pump impeller 2. The pump impeller 2 is a radial pump impeller having a central inlet opening which is arranged adjoining a mouth of the intake connection 11 in the pump chamber 10. The delivery flow which flows against the pump impeller 2 axially through the intake connection 11 is accelerated by the inner blades radially outwards out of the pump chamber 10. An outlet 7 of the pump, formed as a spiral housing 12, adjoins the periphery of the pump chamber 10 and terminates in a pressure connection, not shown, whereby the accelerated delivery flow is discharged from the pump housing 1.

A rotating slide ring 4 is arranged on an axial end of the pump impeller 2 and surrounds the inlet opening of the pump impeller 2 and rotates together with the pump impeller 2. The rotating slide ring 4 is fitted into the pump impeller 2 through an annular groove and is fixed for conjoint rotation therewith. Axially opposite thereto, a static slide ring 5 is arranged on the pump housing 1 and surrounds a mouth of the intake connection 11 in the pump chamber 10 in a radial region of the rotating slide ring 4. The static slide ring 5 is fitted into the pump housing 1 through an annular groove and is fixed for conjoint rotation therewith.

Owing to the axially displaceable mounting of the pump shaft 3 in the radial bearing 13, the pump impeller 2 can move axially in relation to the pump housing 1. Owing to the pressure difference between the lower pressure p1 in a central intake region of the intake connection 11 and a higher pressure p2 in a radially outer compression region of the spiral housing 12, the pump impeller 2 is drawn towards the intake connection 11 during operation of the coolant pump until the rotating slide ring 4 on the pump impeller 2 runs against the static slide ring 5 on the pump housing 1. A sliding surface 40 of the rotating slide ring 4 facing the pump housing 1 and a sliding surface 50 of the static slide ring 5 facing the pump impeller 2 thus together form an axial bearing. This axial bearing and the radial bearing 13 of the pump shaft 3 serve together as a mounting for the rotation of the pump impeller 2 in the pump chamber 10 of the pump housing 1.

A microstructure, not shown, is incorporated on a sliding surface 40, 50 of the axial bearing. The microstructure contains cavities in which the coolant is collected on the surface. Owing to a multiplicity of cavities, distributed over the surface, in the microstructure, a surface wetting is hereby achieved which adheres with sufficient pressure perpendicular to the surface, i.e. a hydrostatic pressure, even when subjected to shearing forces in parallel with the surface. This means that even when the sliding surfaces 40, 50 rotate with respect to each other, surface wetting perpendicular to the rotational axis is not stripped away. Therefore, during operation a hydrodynamic lubricating film is created between the pump impeller 2 and the pump housing 1 which, over the majority of the service life, prevents the rotating slide ring 4 from running into direct contact against the static slide ring 5 and at the same time reduces friction in the axial bearing. Furthermore, the hydrostatic pressure zone between the two sliding surfaces 40, 50 constitutes a barrier against leakage of the delivery flow between the compression region and the intake region. Therefore, during operation of the pump, part of the delivery flow at the higher pressure p2 can effectively be prevented from escaping from the spiral housing 12 back in the direction of the intake connection 11 at which the lower pressure p1 prevails.

The microstructure preferably contains cavities having dimensions, the depth of which is in a range of 10 to 40 μm and the width and length of which are in a range of 15 to 200 μm. In a cross-section in the depth direction, the cavities have a substantially round contour and, in relation to the surface, have a closed contour. This is produced e.g. by incorporating cavities in the form of a spherical cap. Alternatively, the cavities can have the shape of ellipsoid caps, elongate holes or grooves, wherein a longitudinal axis or a transverse axis of the contour is oriented in relation to a radial direction or a peripheral direction of the annular sliding surface 40, 50.

In a first embodiment, the axial bearing is formed from a static slide ring 5, made from a metal, and a rotating slide ring 4, made from a metal, wherein the microstructure is incorporated into both sliding surfaces 40, 50 of the slide rings 5.

In a variant of the first embodiment, the axial bearing is formed from a static slide ring 5, made from a metal, and a rotating slide ring 4, made from a metal, wherein the microstructure is incorporated only into the sliding surface 50 of the static slide ring 5.

In a second embodiment, the axial bearing is formed from a static slide ring 5, made from a ceramic, and a rotating slide ring 4, made from a ceramic, wherein the microstructure is incorporated into both sliding surfaces 40, 50 of the slide rings 5.

In a variant of the second embodiment, the axial bearing is formed from a static slide ring 5, made from a ceramic, and a rotating slide ring 4, made from a ceramic, wherein the microstructure is incorporated only into the sliding surface 50 of the static slide ring 5.

In a third embodiment, the axial bearing is formed from a static slide ring 5, made from a synthetic material, and a rotating slide ring 4, made from a synthetic material, wherein the microstructure is incorporated into both sliding surfaces 40, 50 of the slide rings 5.

In a variant of the third embodiment, the axial bearing is formed from a static slide ring 5, made from a synthetic material, and a rotating slide ring 4, made from a synthetic material, wherein the microstructure is incorporated only into the sliding surface 50 of the static slide ring 5.

In a fourth embodiment, the axial bearing is formed from a static slide ring 5, made from an elastomer, and a rotating slide ring 4, made from an elastomer, wherein the microstructure is incorporated into both sliding surfaces 40, 50 of the slide rings 5.

In a variant of the fourth embodiment, the axial bearing is formed from a static slide ring 5, made from an elastomer, and a rotating slide ring 4, made from an elastomer, wherein the microstructure is incorporated only into the sliding surface 50 of the static slide ring 5.

In a preferred fifth embodiment, the axial bearing is formed from a static slide ring 5, made from a viscoplastic elastomer, and a rotating slide ring 4, made from a metal, wherein the microstructure is incorporated only into the sliding surface 50 of the static slide ring 5. The sliding surface 40 of the rotating slide ring 4 made from metal has a substantially smooth surface with a low level of roughness. In contrast, the viscoplastic property of the elastomer, which the microstructure has, has the following advantageous effect on a response behavior when building up the hydrodynamic lubricating film.

The cavities are deformed when pressure is exerted on the cavities by a perpendicular directional component to the plane of the sliding surface 50, or, owing to static or sliding friction, shearing forces act in the direction of the sliding surface 50 on remaining portions or webs of the sliding surface 50 between the cavities. The deformation results in a reduction in the volumes of the cavities, whereby some of the coolant, held in a capillary manner, is discharged into the sealing gap between the sliding surface 50 and the sliding surface 40. As a result, surface wetting of the sliding surface 50, locally bound by collection at the cavities, is supported by an additional discharge of liquid from deformation of the cavities at the beginning of the build-up of the hydrodynamic lubricating film. After initiation of the rotational movement between the sliding surfaces 40, 50, the cavities in the viscoplastic elastomer resume their reversible original shape accommodating the discharged volume of coolant.

In a variant of the preferred fifth embodiment, the axial bearing is formed from a static slide ring 5, made from a viscoplastic elastomer, and a rotating slide ring 4, made from a ceramic, wherein the microstructure is incorporated only into the sliding surface 50 of the static slide ring 5.

In an alternative variant of all the embodiments, provision is made that the axial bearing is formed from a combination of a static slide ring 5 from the above-mentioned embodiments and a rotating slide ring 4 from the above-mentioned embodiments.

In a further possible variant of all the embodiments, provision is made that the microstructure is incorporated only in the sliding surface 40 of the rotating slide ring 4.

Alternatively, the microstructure can have a mixture of cavities from the various shapes, such as a spherical cap, an ellipsoid cap, an elongate hole or a groove, wherein a longitudinal axis or a transverse axis of the contour of the respective shapes can have identical or different orientations in relation to a radial direction or a peripheral direction of the annular sliding surfaces 40, 50.

In an alternative design of the coolant pump, not shown, the pump impeller 2 can move axially within the pump chamber 10 by means of a plug-in coupling. In this case, the pump shaft 3 can be mounted radially and axially or merely radially. The pump impeller 2 is accommodated by a plug-in connection on the pump shaft which provides a form-fitting connection in the rotational direction and allows a clearance in the axial direction.

Furthermore, the invention can be implemented not only on a coolant pump of the radial pump-type but also on a coolant pump of the axial pump-type or semi-axial pump-type.

### LIST OF REFERENCE SIGNS

1 pump housing
2 pump impeller
3 pump shaft
4 rotating slide ring
static slide ring
6 inlet
7 outlet
pump chamber
11 intake connection
12 spiral housing
13 radial bearing
p1 lower pressure
p2 higher pressure

1. A coolant pump for delivering a coolant circulation, comprising:
a pump housing with a pump chamber in which a pump impeller is rotatably accommodated, an inlet and an outlet which are connected to the pump chamber, wherein a mouth of the inlet into the pump chamber is directed towards an entry opening of the pump impeller;
a pump shaft rotatably mounted on the pump housing and extending from a side opposite the inlet into the pump chamber wherein the pump impeller is mounted in an axially movable manner relative to the pump housing and is mounted for conjoint rotation with the pump shaft;
a rotating slide ring arranged on the pump impeller towards an axial end of the entry opening;
a static slide ring arranged on the pump housing around the mouth of the inlet opposite the rotating slide ring;
wherein the rotating slide ring has a sliding surface, and the static slide ring has a sliding surface, wherein the sliding surface of the rotating slide ring and the sliding surface of the static slide ring face one another and form a sliding bearing that receives a force directed axially away from the pump impeller to the pump housing; and
wherein a microstructure for creating a hydrodynamic lubricating film between the sliding surfaces is formed on at least one of the sliding surfaces facing one another, the microstructure comprises cavities configured to collect liquid coolant on the at least one sliding surface.

2. The coolant pump according to claim 1, wherein a material of the rotating slide ring and/or a material of the static slide ring is different from a material of the pump housing and from a material of the pump impeller.

3. The coolant pump according to claim 1, wherein the microstructure is formed on the sliding surface of the rotating slide ring and on the sliding surface of the static slide ring.

4. The coolant pump according to claim 1, wherein the rotating slide ring and the static slide ring or at least a portion of the sliding surface of the rotating slide ring or the sliding surface of the static slide ring same forming the sliding surface is made of a material or of a composite based on an elastomer or a synthetic resin.

5. The coolant pump according to claim 1, wherein the rotating slide ring and the static slide ring or at least a respective portion of the sliding surface of the rotating slide ring or the sliding surface of the static slide ring is made of a material or of an alloy based on a metal or a ceramic.

6. The coolant pump according to claim 1, wherein the microstructure is formed only on the sliding surface of the static slide ring.

7. The coolant pump according to claim 6, wherein the static slide ring or at least a portion of the static slide ring forming the sliding surface of the static slide ring is made of a material or of a composite based on an elastomer or a synthetic resin.

8. The coolant pump according to claim 6, wherein the rotating slide ring or at least a portion of the rotating slide ring forming the sliding surface of the rotating slide ring is made of a material or of an alloy based on a metal or a ceramic.

9. The coolant pump according to claim 1, wherein the cavities of the microstructure have a closed contour towards a surface of the sliding surface of the rotating slide ring or the sliding surface of the static slide ring.

10. The coolant pump according to claim 1, wherein the cavities of the microstructure have a dimension of 10 μm to 40 μm in a depth direction to a surrounding surface.

11. The coolant pump according to claim 1, wherein the cavities of the microstructure have a dimension of 15 μm to 200 μm in a direction of a shortest extension to a surrounding surface.

12. The coolant pump according to claim 1, wherein the cavities have a shape of a spherical cap, of an ellipsoid cap, of an elongate hole, or of a groove.

13. The coolant pump according to claim 1, wherein the sliding surface of the rotating slide ring and the sliding surface of the static slide ring that face one another are perpendicular to the pump shaft.

14. The coolant pump according to claim 1, wherein the pump impeller is directly connected to the pump shaft, and the pump shaft is mounted in an axially movable manner relative to the pump housing.

15. The coolant pump according to claim 1, wherein the pump impeller is arranged in an axially movable manner on the pump shaft and coupled by means of a plug-in coupling.
